(19) United States
(12) Patent Application Publication
(10) Pub. No.: US 2011/0238701 A1
(43) Pub. Date: Sep. 29, 2011

(54) Method And Apparatus For Associating User With Friend In Network Community

(75) Inventors: Zhu Liang, Shenzhen City (CN); Shixiong Cao, Shenzhen City (CN)

(73) Assignee: TENCENT TECHNOLOGY (SHENZHEN) COMPANY LIMITED, Shenzhen City (CN)

(21) Appl. No.: 13/154,800

(22) Filed: Jun. 7, 2011

Related U.S. Application Data
(63) Continuation of application No. PCT/CN2009/075393, filed on Dec. 8, 2009.

(30) Foreign Application Priority Data
Dec. 24, 2008 (CN) 200810189407.8

(51) Int. Cl. G06F 17/30

(52) U.S. Cl. 707/780; 707/E17.014

(57) ABSTRACT

An apparatus for associating a user and a friend in a network community. The apparatus extracts a property element from user personal information and searches for resources related to the property element in a network community. The apparatus also determines a friend to be recommended according to the resources, and associates the friend with the user.

### CROSS-REFERENCE TO RELATED APPLICATIONS

This application is a continuation of International Application No. PCT/CN2009/075393, filed Dec. 8, 2009. This application claims the benefit and priority of Chinese Patent Application No. 200810189407.8, filed Dec. 24, 2008. The entire disclosures of each of the above applications are incorporated herein by reference.

### FIELD

The present disclosure relates to computer and communication technologies and to a method and apparatus for associating a user with a friend in a network community.

### BACKGROUND

This section provides background information related to the present disclosure which is not necessarily prior art.

With the development of Internet, a network community is widely used by users. In the network community, a user may create their own profile which includes pictures and interests, and the like, leave word publicly or privately to another user, and participate in a group of other buddies. In order to enhance the relation between users, the network community may recommend a friend to the user. In the present teachings, the “user” and “friend” are relative, and for a certain user in the network community, other users may be potential buddies of the user and become objects to be recommended.

In some present systems, the network community recommends a friend to the user by using a random recommending mode. In some network communities, the random recommending mode is usually applied to VIP users. Because a friend is recommended randomly to the user in the random recommending mode, the user has no relation with the friend, does not know the friend, and can not understand why the friend is recommended, thus the user lacks motivity of long-term attending to the friend.

In other present systems, the network community recommends a friend to the user through a relation chain which specifically includes (1) obtaining a friend list of the user, (2) searching a friend list of the user's friend to search out buddies who do not appear in the friend list of the user, and (3) recommending these buddies to the user randomly. The system improves on the first system described above, but in practical applications, the friend relation chain of the user and the friend relation chain of the friend may be very different. It is thus difficult to determine the relation between the user and the friend to be recommended by using the second technical solution. The user may not even know the friend's friend. In this way, the friend to be recommended may not be attended to by the user.

Thus, it is needed to provide a new method for associating a user with a friend in a network community, so as to enhance the relation between the user and the friend to be recommended, and further improve the communication between the user and the friend in the network community.

### SUMMARY

This section provides a general summary of the disclosure, and is not a comprehensive disclosure of its full scope or all of its features.

The present teachings provide a method and apparatus for associating a user with a friend in a network community to enhance the relation between the user and the friend to be recommended.

In various embodiments, the present disclosure is directed to an apparatus for associating a user and a friend in a network community. The apparatus includes an extracting unit configured to extract a property element from user personal information. A searching unit searches for resources related to the property element in a network community. An associating unit determines a friend to be recommended according to the resources found by the searching unit and associates the friend with the user.

The present disclosure is also directed to a method for associating a user and a friend in a network community and includes extracting a property element from user personal information. The present disclosure also includes searching for resources related to the property element in a network community. The present disclosure also includes determining a friend to be recommended according to the resources found, and associating the friend with the user.

It can be seen that the various embodiments can include extracting a property element from user personal information, searching for resources related to the property element in the network community, determining a friend to be recommended according to the found resources, and associating the friend with the user. The user is associated with the friend to be recommended through the property element. That is, the user and the friend to be recommended have a certain relation so as to enhance the relation between the user and the friend to be recommended and further improve the communication between the user and the friend in the network community.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating the structure of an apparatus for associating a user with a friend in a network community according to various embodiments;

FIG. 2 is a schematic diagram illustrating the structure of an apparatus for associating a user with a friend in a network community according to according to various embodiments;

FIG. 3 is a flowchart illustrating a method for associating a user with a friend in a network community according to according to various embodiments; and

FIG. 4 is a flowchart illustrating a method for associating a user with a friend in a network community according to various embodiments.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In order to make the object, technical solutions and merits clearer, the various embodiments will be illustrated hereinafter in detail with reference to the accompanying drawings and examples.

The various embodiments include extracting a property element from user personal information, searching for resources related to the property element in the network community, determining a friend to be recommended according to the found resources, and associating the friend with the user. As can be seen, the various embodiments improve the conventional random recommending mode into a directional recommending mode to some degree, so as to enhance the relation between the user and the friend to be recommended, and make the user have a stronger and longer interest in the friend to be recommended.

FIG. 1 is a schematic diagram illustrating the structure of an apparatus for associating a user with a friend in a network community according to various embodiments. The apparatus includes an extracting unit 10, a searching unit 20, and an associating unit 30.

The extracting unit 10 is configured to extract a property element from user personal information. The searching unit 20 is connected with the extracting unit 10 and is configured to search for resources related to the property element in a network community. The associating unit 30 is connected with the searching unit 20 and is configured to determine a friend to be recommended according to the found resources, and associate the friend with the user.

According to various embodiments, the extracting unit 10 determines and extracts the property element in the user personal information and sends the property element to the searching unit 20. The user personal information can include all information related to the user, such as information configured by the user. In a non-limiting example, the user personal information may include a user personal profile recorded by the user, or contents published by the user, such as logs, albums, and emotion words of the user.

The property element refers to contents related to an object to be associated with the user in the user personal information, such as contents in which other users may be interested. In a non-limiting example, if the user personal information refers to the user personal profile recorded by the user, the property element may be an interest item in the user personal profile. Of course, the property element may be other contents, as long as the contents relate to the user and may be attended to by other users, which are not limited in the present invention.

In a non-limiting example, the searching unit 20 searches for the resources related to the property element in the network community. The searching unit 20 may be a searching engine in general, and can adopt multiple searching modes. In various embodiments, the searching mode includes taking the property element as a key word, and searching for resources containing the key word in the network community.

The resources of the various embodiments include all data in the network community. In a non-limiting example, the resources refer to network logs. The resources may be albums, the emotion words of the user and so on, which are not used to limit the protection scope of the various embodiments.

In a non-limiting example, the searching unit 20 searches for the resources according to the property element, returns all network logs with relativity recorded within a predefined period, such as 3 days. The relativity, in the simplest case, refers to the property element that appears at least one time in the network log.

In a non-limiting example, the associating unit 30 determines a friend to be recommended according to the found resources, and recommends the friend to the user. In various embodiments, the friend to be recommended may be determined through multiple modes and may also be recommended to the user through multiple modes.

In various embodiments, the mode of determining the friend to be recommended by the associating unit 30 includes performing text relativity analysis for the found resources, selecting a friend with a relativity reaching a threshold, and determining the friend as a friend to be recommended. The relativity may be calculated by using multiple modes. By way of non-limiting example, the times that the property element appears in the resources is counted, the threshold of the relativity is defined as K; if the times that the property element appears in the resources reaches K, a friend corresponding to the resources is determined as the friend to be recommended. According to various embodiments, the relativity may be represented through multiple modes. By way of non-limiting example, the relativity may be presented to the user through a value, such as a percent value, so as to make the user determine the friend to be accepted according to the value. The above mode is not used to limit the protection scope of the present teachings.

In various embodiments, the mode of recommending the friend to the user by the associating unit 30 includes listing the friend in a recommendation list, and displaying the recommendation list on a user interface. The mode is not used to limit the protection scope of the present invention.

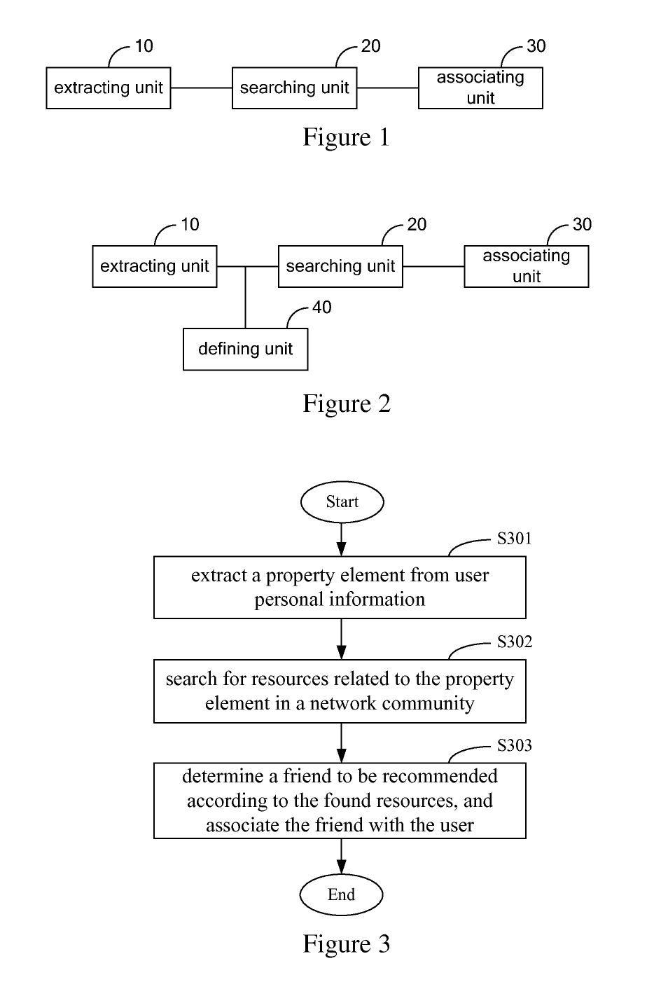

FIG. 2 is a schematic diagram illustrating the structure of an apparatus for associating a user with a friend in a network community according to various embodiments. The apparatus includes an extracting unit 10, a searching unit 20, an associating unit 30 and a defining unit 40.

The defining unit 40 is connected with the extracting unit 10 and the searching unit 20, and is configured to automatically append a definitive to the extracted property element, and send the property element with the definitive to the searching unit 20. In various embodiments, the user records in the user personal profile that “a teleplay watched currently” is “our marriage”; if the property element extracted by the extracting unit 10 is “our marriage”, in order to control the relativity, the defining unit 40 automatically appends a definitive to the property element according to preset functions, e.g. appends “teleplay” to “our marriage”, and then searches for the resources according to the combination of “teleplay” and “our marriage”.

FIG. 3 is a flowchart illustrating a method for associating a user with a friend in a network community according to various embodiments. In block S301, a property element is extracted from user personal information. In block S302, resources related to the property element is searched for in a network community. In block S303, a friend to be recommended is determined according to the found resources, and the friend is associated with the user. In block S301, the user personal information includes all information related to the user, such as information configured by the user. In a non-limiting example, the user personal information may include a user personal profile recorded by the user, or contents published by the user, such as logs, albums, and emotion words of the user.

The property element refers to contents in which other users may be interested. In a non-limiting example, if the user personal information refers to the user personal profile recorded by the user, the property element may be an interest item in the user personal profile. The property element may be other contents, as long as the contents relate to the user and may be attended to by other users, which are not limited in the present invention.

In block S302, there are multiple searching modes. In a non-limiting example, the searching mode includes taking the property element as a key word, and searching for resources containing the key word in the network community.

The resources in various embodiments include all data in the network community. In a non-limiting example, the resources refer to network logs. The resources may be albums, the emotion words of the user and so on, which are not used to limit the protection scope of the present teachings.

In a non-limiting example, the searching in block S302 may be performed according to the property element, return all network logs with relativity recorded within a predefined period, such as 3 days. The relativity, in the simplest case, refers to that the property element appears at least one time in each network log. In block S303, the friend to be recommended may be determined through multiple modes, and may also be recommended to the user through multiple modes.

In a non-limiting example, the mode of determining the friend to be recommended includes performing text relativity analysis for the found resources, selecting a friend with a relativity reaching a threshold, and determining the friend as a friend to be recommended. The relativity may be calculated by using multiple modes. In various embodiments, the times that the property element appears in the resources is counted, the threshold of the relativity is defined as K. If the times that the property element appears in the resources reaches K, a friend corresponding to the resources is determined as the friend to be recommended. In various embodiments, the relativity may be represented through multiple modes. By way of non-limiting example, the relativity may be presented to the user through a value, such as a percent value, so as to make the user determine the friend to be accepted according to the value. In a non-limiting example, the mode of recommending the friend to the user in block S303 includes listing the friend in a recommendation list and displaying the recommendation list on a user interface.

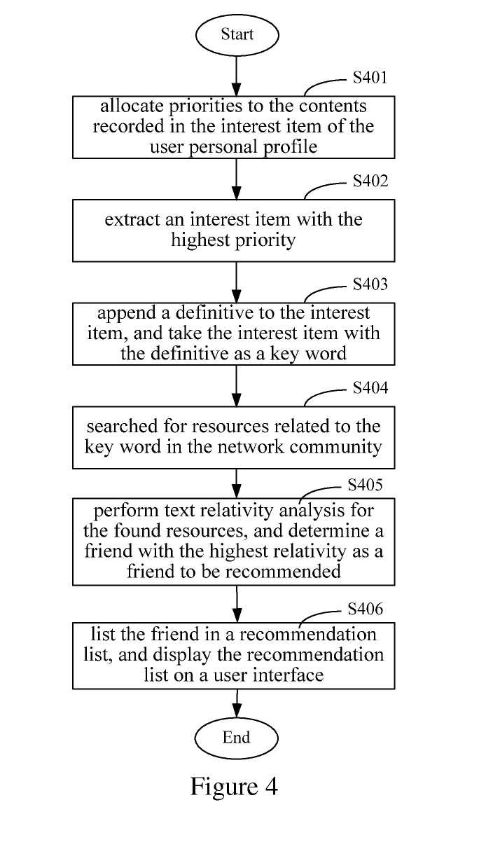

FIG. 4 is a flowchart illustrating a method for associating a user with a friend in a network community according to various embodiments. The method includes the following. In block S401, priorities are allocated to contents recorded in the interest item of the user personal profile. The objective of allocating the priorities is to find an element making strangers become friends more easily. In various embodiments, the priorities are defined according to the recording amount and update frequency of the user, and potential commercial merits. The priorities include multiple levels, and a mapping relation is established between different interest items and the levels.

In block S402, an interest item with the highest priority is extracted and is taken as a property element. In a non-limiting example, the priority of the most expectant film, the currently played game and the fondest perfume brand is higher than the priority of the most adept sport. In block S403, a definitive is appended to the interest item and the interest item with the definitive is taken as a key word.

In various embodiments, the user records in the user personal profile that “a teleplay watched currently” is “our marriage”; if the property element extracted in block S402 is “our marriage”, in order to control the relativity, in block S402 a definitive is automatically appended to the property element, e.g. “teleplay” is appended to “our marriage”, and then the resources is searched for according to the combination of “teleplay” and “our marriage”. In block S404, resources related to the key word are searched for in the network community. The searching mode is similar to the conventional searching mode. In block S405, text relativity analysis is performed for the found resources, and a friend with the highest relativity is determined as a friend to be recommended. In block S406, the friend is listed in a recommendation list, and the recommendation list is displayed on a user interface. It should be noted that other recommending modes can be used except the above mode.

The foregoing describes various embodiments and is not for use in limiting the protection scope of the present teachings. Any modification, equivalent replacement and improvement made within the scope of the present teachings should be covered under the protection scope of the present teachings.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An apparatus for associating a user with a friend in a network community, comprising:
an extracting unit, the extracting unit extracting a property element from user personal information;
a searching unit, the searching unit searching for resources related to the property element in a network community; and
an associating unit, the associating unit determining a friend to be recommended according to the resources found by the searching unit, and associate the friend with the user.

2. The apparatus of claim 1, wherein the user personal information comprises at least one of a user personal profile and contents published by the user.

3. The apparatus of claim 1, wherein the user personal information comprises an interest item of the user, and the interest item records information contents in which the user is interested; and
the extracting unit allocates priorities to the information contents recorded in the interest item in the user personal information, and determine information contents with the highest priority as the property element to be extracted currently.

4. The apparatus of claim 3, further comprising:
a defining unit automatically appending a definitive to the property element extracted by the extracting unit, and sending the property element with the definitive to the searching unit;
the searching unit taking the received property element with the definitive as a key word, searching for resources containing the key word in the network community or searching for resources which contains the key word and is published within a predefined period in the network community.

5. The apparatus of claim 1, wherein the resources comprise a network log.

6. The apparatus of claim 1, wherein the associating unit performs text relativity analysis for the resources found by the searching unit and determines a friend with the relativity reaching a relativity threshold as the friend to be recommended.

7. The apparatus of claim 1, wherein the associating unit lists the friend to be recommended in a recommendation list and displays the recommendation list on a user interface.

8. A method for associating a user with a friend in a network community, comprising:
extracting a property element from user personal information;
searching for resources related to the property element in a network community; and
determining a friend to be recommended according to the resources found and associating the friend with the user.

9. The method of claim 8, wherein the user personal information comprises at least one of a user personal profile and contents published by the user.

10. The method of claim 8, wherein the user personal information comprises an interest item of the user, and the interest item records information contents in which the user is interested; the extracting further comprises:
allocating priorities to the information contents recorded in the user interest item in the user personal information; and
determining information contents with the highest priority as the property element to be extracted currently.

11. The method of claim 8, further comprising:
automatically appending a definitive to the extracted property element; and
the searching further comprises:
taking the property element with the definitive as a key word and searching for resources containing the key word in the network community; or
taking the property element with the definitive as a key word and searching for resources which contains the key word and is published within a predefined period in the network community.

12. The method of claim 8, wherein the resources comprise a network log.

13. The method of claim 8, further comprising configuring a relativity threshold; and
the determining comprises performing text relativity analysis for the resources found and determining a friend with the relativity reaching the relativity threshold as the friend to be recommended.

14. The method of claim 8, wherein associating the friend to the user comprises listing the friend to be recommended in a recommendation list, and displaying the recommendation list on a user interface.
